(19) United States
(12) Patent Application Publication
(10) Pub. No.: US 2009/0187834 A1
(43) Pub. Date: Jul. 23, 2009

(54) Method and system for implementing a single user computer application in a multi-user session

(75) Inventors: Andrew Rapo, Studio City, CA (US); Christopher Thomes, Encino, CA (US); Allan Jones, Valencia, CA (US); Steven Parkis, Valencia, CA (US); Paul Yanover, Los Angeles, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., Burbank, CA (US)

(21) Appl. No.: 12/009,240

(22) Filed: Jan. 17, 2008

(51) Int. Cl. G06F 3/048

(52) U.S. Cl. 715/758; 715/753

(57) ABSTRACT

There is provided a method of implementing a single user computer application in a multi-user session comprising receiving a request to access the single user computer application, opening a first multi-user session, tolling a pre-run phase of the first multi-user session, and initiating a run phase during which concurrent running of the single user computer application by each user in a multi-user pool is monitored and data corresponding to a performance of every user is provided to each user. A system for implementing a single user computer application in a multi-user session comprises a multi-user implementation server, a single user computer application database including the single user computer application, a multi-user shell application configured to provide an interface between the single user computer application and a multi-user control application capable of coordinating concurrently running the single user computer application by every user in a multi-user pool.

### BACKGROUND OF THE INVENTION

1. Field of the Invention

The present invention relates generally to the distribution of information content. More particularly, the present invention relates to the distribution of computer based interactive content.

2. Background Art

Seemingly long ago, in a virtual space far removed from that occupied by modern computer applications, video games like Asteroids and Pac-Man introduced the general public to the pleasure and diversion available from computer based interactive content. In their wake, a plethora of diverse computer mediated information content, including entertainment content, and educational and training content, was developed and refined. Entertainment content, for example, included shooting games, arcade games such as pinball, racing games, trivia games, and even virtual chess matches, to satisfy the growing consumer appetite for computer games. Educational and training content included learning modules covering a wide variety of subject matter, frequently accompanied by computer based tests to confirm or reinforce learning. The early computer applications developed to distribute this information content were typically single user computer applications, and in the case of computer gaming applications in particular, many developed a loyal popular following.

Single user computer applications, however, can impose a significant constraint on the quality of the user experience. To use gaming as an illustrative example, in a single player game, one player at a time may compete against the game during a single player session, accumulating a personal game score. Although that game score can be manually compared to a score achieved by another player engaging in a separate single player session of the same game, in an ad hoc manner, that unstructured approach to simulating game competition between multiple players proves less than satisfying for several reasons. On reason for dissatisfaction is that scores are being compared from different gaming sessions played under different game conditions. For example, in a trivia game, comparing the number of correct answers provided by a player is less meaningful when the questions being posed are different, which is often the case in different sessions of the same game in which questions may be randomly selected from a trivia question database. In addition, the ad hoc approach includes the disadvantage of forcing one player to remain idle while another engages the game, thereby robbing the competitive experience of much of its zest.

A conventional solution to the challenge of allowing multiple players to experience the same game session concurrently has been to develop multi-player games. Due in part to their relatively recent introduction, and the advances in both computer processing capability and user sophistication having occurred since the advent of the early single player games, many multi-player games comprise new gaming content, rather than a repackaging of the original single player gaming content. These new gaming products permit players to engage in the same gaming session not only concurrently, but often interactively with one another as well, so that the actions of one player within the game can alter the score of another player, or the gaming environment for all players, for example. Although providing a rich and highly interactive competitive gaming environment, conventional multi-player games can be dauntingly complex and challenging to play, requiring considerable user mastery of the gaming software. In addition, conventional multi-player games may include complicated launch protocols for identifying and pooling players in a multi-player game session. Moreover, the computer resources required to run many new multi-player games can be quite high, restricting the pool of players to those with access to sufficiently powerful gaming platforms.

Thus, while perhaps providing a rich and satisfying gaming experience for those players having sufficient expertise and adequate computing resources to utilize multi-player products, the conventional approach largely ignores those prospective players lacking in computer sophistication, computing resources, or both. Consequently, the conventional approach fails to take into account the interests of fans and potential fans of classical single player games by failing to provide a solution making those popular, user friendly, classic single player games accessible in a multi-player format. An analogous deficiency in the development of educational and training computer applications has marginalized those users seeking access to straightforward, simple, learning modules in a multi-user format.

Accordingly, there is a need to overcome the drawbacks and deficiencies in the art by providing a solution enabling implementation of popular or traditional single user computer applications as multiple user experiences, while retaining the simplicity and ease of use of the original products.

### SUMMARY OF THE INVENTION

A method and system for implementing a single user computer application in a multi-user session, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for implementing a single user computer application in a multi-user session, according to one embodiment of the present invention;

FIG. 2 shows a more detailed exemplary embodiment of a system for implementing a single user computer application in a multi-user session, according to one embodiment of the present invention;

FIG. 3A shows a visual frame corresponding to a screen display provided during a pre-run phase in a method of implementing a single user computer application in a multi-user session, according to one embodiment of the present invention;

FIG. 3B shows a visual frame corresponding to a screen display provided during a run phase in a method of implementing a single user computer application in a multi-user session, according to one embodiment of the present invention; and

FIG. 4 is a flowchart presenting a method of implementing a single user computer application in a multi-user session, according to one embodiment of the present invention.

### DETAILED DESCRIPTION OF THE INVENTION

The present application is directed to a method and system for implementing a single user computer application in a multi-user session. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

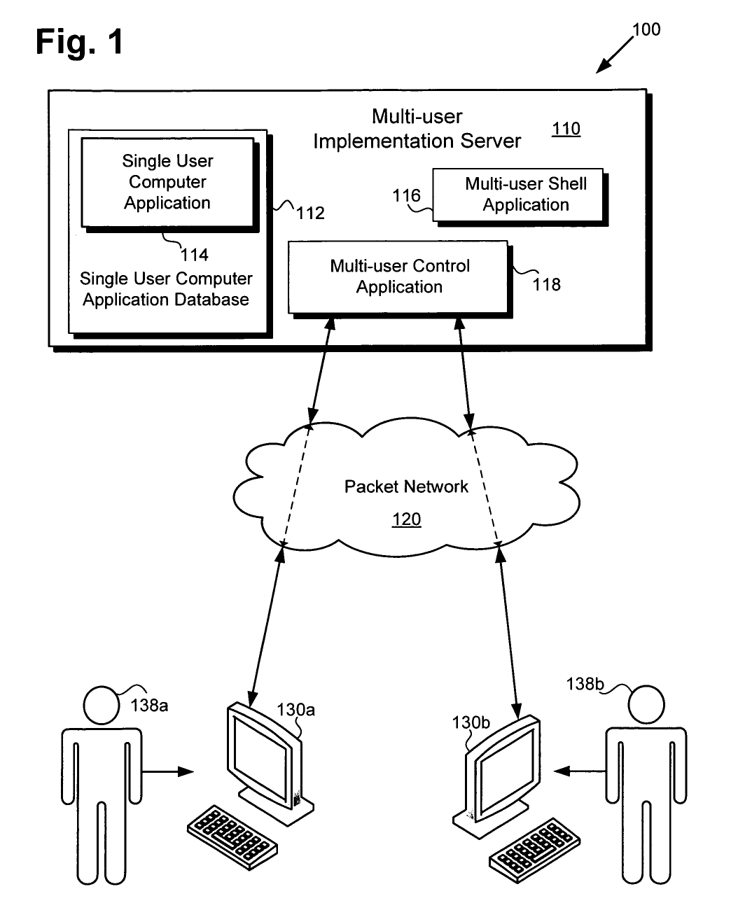

FIG. 1 shows a diagram of an exemplary system for implementing a single user computer application in a multi-user session, according to one embodiment of the present invention. In the embodiment of FIG. 1, system 100 comprises multi-user implementation server 110 including single user computer application database 112 storing singe user computer application 114, multi-user shell application 116, and multi-user control application 118. Also shown in FIG. 1 are packet network 120, client computers 130a and 130b, and users 138a and 138b.

According to the embodiment of FIG. 1, users 138a and 138b, who may be single players seeking to play a computer based game, for example, may utilize respective client computers 130a and 130b, and packet network 120, to separately access single user computer application 114, multi-user shell application 116, and multi-user control application 118, located on multi-user implementation server 110. Multi-user control application 118 can then by utilized in conjunction with multi-user shell application 116 to coordinate concurrently running single user computer application 114 by users 138a and 138b. As a result, single user computer application 114 may be implemented in a multi-user session common to users 138a and 138b. Single use computer application 114 may comprise entertainment content such as a game, or educational content such as a learning module or test, for example. Correspondingly, users 138a and 138b may be players of a game, students, trainees, test takers, or employees, for example. It is noted that although client computers 130a and 130b are represented as personal computers (PCs) in FIG. 1, in one embodiment one or both of client computers 130a and 130b may be a mobile communication device such as a mobile telephone, a digital media player, personal digital assistant (PDA), a wireless computer, or a wireless gaming console, for example.

As shown in FIG. 1, multi-user control application 118 can be accessed through packet network 120. In that instance, multi-user control application 118 may comprise a web application, accessible over a packet network such as the Internet, for example. Alternatively, multi-user control application 118 may reside on a server supporting a local area network (LAN), for instance, or included in another type of limited distribution network. In another embodiment, single user computer application database 112 containing single user computer application 114, and multi-user shell application 116, may reside on a portable computer readable storage medium such as a compact disc read-only memory (CD-ROM), for example. Analogously, in another embodiment, single user computer application database 112 and multi-user shell application 116 may reside on a server supporting a LAN or other limited distribution network.

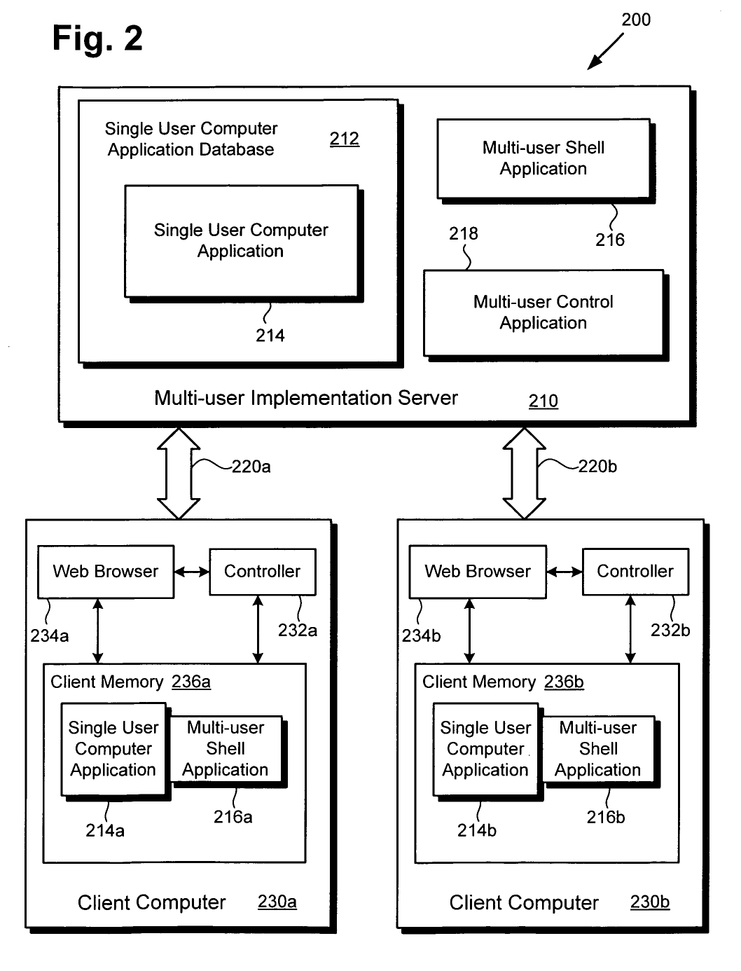

Turning now to FIG. 2, FIG. 2 provides a more detailed embodiment showing exemplary system 200 for implementing a single user computer application in a multi-user session. System 200 in FIG. 2 comprises multi-user implementation server 210 including single user computer application database 212 storing singe user computer application 214, multi-user shell application 216, and multi-user control application 218, corresponding respectively to multi-user implementation server 110 including single user computer application database 112 storing singe user computer application 114, multi-user shell application 116, and multi-user control application 118, in FIG. 1. FIG. 2 also includes client computers 230a and 230b, corresponding respectively to client computers 130a and 130b in FIG. 1.

In the embodiment of FIG. 2, client computers 230a and 230b are receiving respective downloads via communication links 220a and 220b from multi-user implementation server 210. As shown in FIG. 2, client computer 230a includes controller 232a, web browser 234a, and client memory 236a, while client computer 230b similarly includes controller 232b, web browser 234b, and client memory 236b. Also shown in FIG. 2 are single user computer applications 214a and 214b and multi-user shell applications 216a and 216b.

In the present embodiment, single user computer applications 214a and 214b, and multi-user shell applications 216a and 216b, are located in respective client memories 236a and 236b, having been received from multi-user implementation server 210 via respective communication links 220a and 220b. In the embodiment of FIG. 2, communication links 220a and 220b represent download of single user computer application 214 and multi-user shell application 216 over a packet network, for example. In another embodiment, communication links 220a and 220b may represent transfer of single user computer application 214 and multi-user shell application 216 from a CD-ROM or other portable computer readable storage medium. Once transferred, single user computer applications 214a and 214b, and multi-user shell applications 216a and 216b, may be stored in respective client memories 236a and 236b and run locally on respective client computers 230a and 230b.

It is noted that communication links 220a and 220b are shown as two-way communications, to correspond to ongoing communication between client computers 230a and 230b, and multi-user implementation server 210, in which multi-user shell applications 216a and 216b may provide an interface between respective single user computer applications 214a and 214b and multi-user control application 218, for example. Controllers 232a and 232b may be the respective central processing units for client computers 230a and 230b, in which they may run the client computer operating systems, launch web browsers 234a and 234b, and facilitate execution of single user computer applications 214a and 214b, and multi-user shell applications 216a and 216b. Web browsers 234a and 234b, under the control of respective controllers 232a and 232b, may run respective single user computer applications 214a and 214b, and respective multi-user shell applications 216a and 216b, to enable client computers 230a and 230b to interact with multi-user control application 218. Multi-user control application 218 is capable of coordinating concurrently running single user computer applications 214a and 214b by users of client computers 230a and 230b, thereby implementing single user computer applications 214a and 214b in a multi-user session.

Implementation of the embodiment of FIG. 2 permits each respective user of client computers 230a and 230b to run a single user computer application and a multi-user shell application. The respective multi-user shell application provides an interface with multi-user control application 218, which coordinates concurrent execution of the locally run single user computer application, while providing exchange of data amongst the respective multi-user shell applications, corresponding to the performance of every user concurrently running the single user computer application. As a result, the present embodiment implements the single user computer application in a multi-user setting by providing each user with a simulated multi-user experience including the real time feedback representing the presence and performance of every member of a multi-user pool.

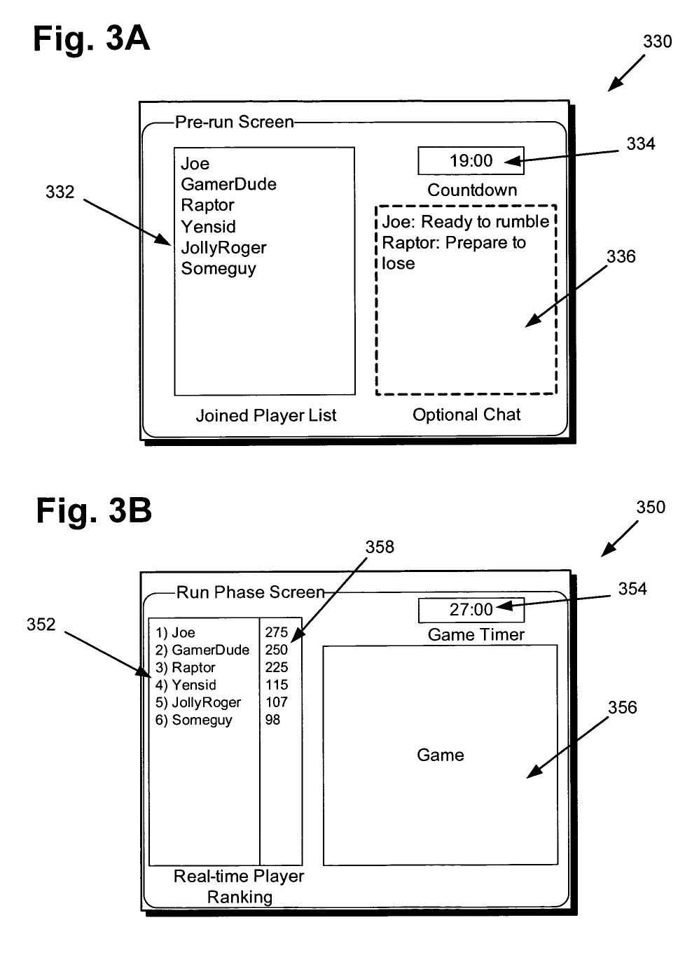

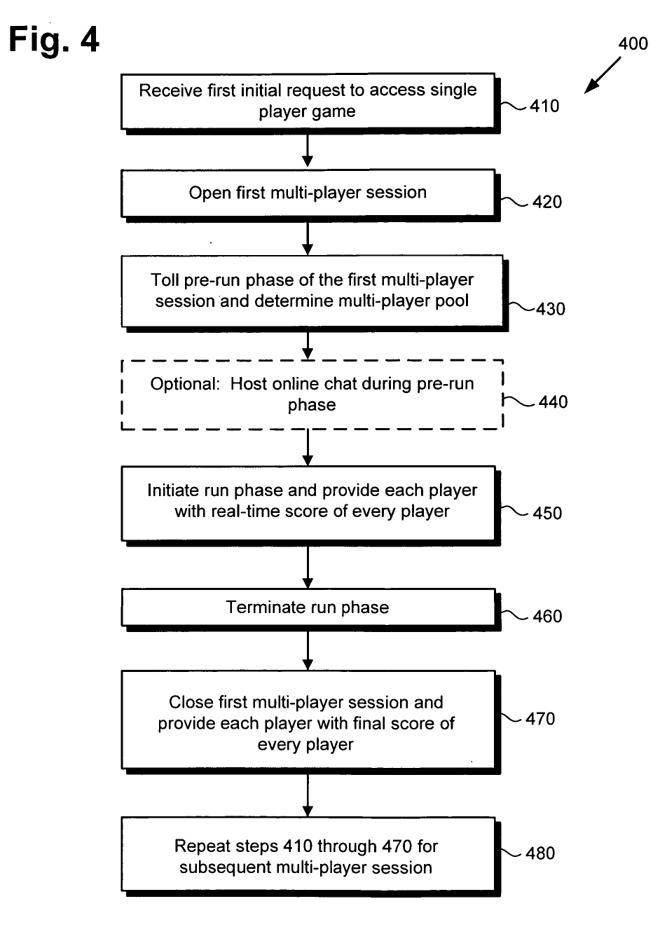

The present invention will now be further described by FIGS. 3A, 3B, and 4. FIG. 3A shows a visual frame corresponding to a screen display provided during a pre-run phase in a method of implementing a single user computer application in a multi-user session, according to one embodiment of the present invention, while FIG. 3B shows an exemplary visual frame corresponding to a screen display provided during a run phase in a method of implementing a single user computer application in a multi-user session. FIG. 4 shows a flowchart presenting an exemplary method of implementing a single user computer application in a multi-user session, capable of producing the displays shown in FIGS. 3A and 3B.

FIG. 3A shows exemplary pre-run screen 330 provided during a pre-run phase in a method of implementing a single player game in a multi-player game session. In the embodiment of FIG. 3A, pre-run screen 330 includes joined player list 332, countdown timer 334, and optional chat screen 336. Continuing to FIG. 3B, FIG. 3B shows run phase screen 350 provided during a run phase in a method of implementing a single player game in a multi-player game session. Run phase screen 350 includes real-time player ranking 352, game timer 354, game screen 356, and real-time score column 358 providing data corresponding to the performance of every player joined in a multi-player game session.

FIG. 4, meanwhile, shows flowchart 400 describing the steps, according to one embodiment of the present invention, of implementing a single player computer game in a multi-player game session. Certain details and features have been left out of flowchart 400 that are apparent to a person of ordinary skill in the art. For example, a step may comprise one or more substeps or may involve specialized equipment or materials, as known in the art. While steps 410 through 480 indicated in flowchart 400 are sufficient to describe one embodiment of the present invention, other embodiments of the invention may utilize steps different from those shown in flowchart 400, or may include more, or fewer steps.

Referring to step 410 of flowchart 400, and system 200 in FIG. 2, step 410 comprises receiving a first initial request to access the single player computer game from a first player. More generally, step 410 corresponds to a method step of receiving a first initial request to access a single user computer application from a first user, wherein the terms “player” and “game” are equivalent to “user” and “application” for the purposes of the present embodiment. Step 410 may correspond to a user of either client computer 230a or 230b communicating with multi-user implementation server 210, for example.

The exemplary method of flowchart 400 continues with step 420, which comprises opening a first multi-user session. Opening a first multi-user session includes starting a pre-run phase of the first multi-user session during which other users desiring to experience the single user computer application, in this instance other players desiring to join the present session of the multi-player game session, may join. Step 420 is shown in FIG. 3A by pre-run screen 330 displayed to players joined to the present multi-player game session. As players are joined data corresponding to their user names or other game identifier appears in joined player list 332.

Flowchart 400 continues with step 430, comprising tolling a pre-run phase of the first multi-player session and determining a multi-player pool. The pre-run phase, which may last from ten to thirty seconds, for example, provides a time window during which additional players may be joined to the present multi-player game session. It is during the pre-run phase that a multi-player pool is determined, the multi-player pool including the first player and one or more players joined during the pre-run phase. Tolling of the pre-run phase in step 430 is shown in FIG. 3A by countdown timer 334, which shows the time remaining in the pre-run phase. In the example shown by pre-run screen 330, for example, nineteen seconds remain for additional players to join the present multi-player game session. In one embodiment, additional players are added to the multi-player pool dynamically, in response to a request to participate in a single player computer game during the pre-run phase of a multi-player game session, for example. In that embodiment, the individual players are not required to know one another, or to take additional affirmative steps to arrange a multi-player game session, thus streamlining multi-player game session organization and launch, and minimizing the user sophistication required of individual players.

Flowchart 400 includes optional step 440, which comprises hosting an online chat for the players joined in the multi-player pool during the pre-run phase. Optional step 440 is shown in FIG. 3A by the presence of optional chat screen 336 in pre-run screen 330. As shown in FIG. 3A, optional chat screen 336 provides an opportunity for the players joined to the present multi-player game session to interact prior to the run phase. Because the pre-run phase extends during a window of time to allow players to join the multi-player game session, an optional online chat provides the joined players with entertainment and diversion during tolling of what could otherwise be a tedious delay during the pre-run phase.

Moving now to step 450 of flowchart 400, and run phase screen 350 in FIG. 3B, step 450 of flowchart 400 comprises initiating a run phase of the first multi-player session during which execution of the single player computer game by each player in the multi-player pool is monitored, and data corresponding to the performance of every player in the multi-player pool is provided to each player. Where, as in the embodiment of flowchart 400 and FIG. 3B, a single user computer application takes the form of a single player computer game, the data may be presented as a real-time score, as shown by real-time player ranking 352 and real-time score column 358. As may be seen from FIGS. 3A and 3B, providing real-time data corresponding to the performance of every player in the multi-player in step 450, in conjunction with identifying the members joined to the multi-user pool during step 430, creates the effect of real-time presence for the members of the multi-player session. That real-time presence effect may be further enhanced by providing the optional online chat hosted according to optional step 440.

Continuing with step 460 of flowchart 400, step 460 comprises terminating the run phase. Step 460 corresponds to completion of the single user computer application, be it a game, entertainment or learning module, or test, for example. In the embodiment of FIG. 3B, termination of the run phase, during which a game is played concurrently by the members of the multi-user pool, occurs after a predetermined runtime, as shown by game timer 354. In another embodiment, terminating the run phase may correspond to completion, by any single member of the multi-user pool, of one or more tasks, or a set of questions, for example.

Step 470 of flowchart 400 comprises closing the first multi-player session and providing each player with the final score of every player in the multi-player session. As a result of step 470, each player is provided with a summary of the performance of every player during the run phase of the multi-player session, thereby further emphasizing the real-time presence of other members of the multi-player pool. More generally, step 470 comprises closing the first multi-user session and providing each user with final data corresponding to a total first multi-user session performance of every user in the multi-user pool. Where, for example, the single user computer application comprises a test, the final data may take the form of a total test score for each user.

Turning now to step 480 of flowchart 400, step 480 comprises repeating steps 410 through 470 for a subsequent multi-player session. In one embodiment, as described previously, players are dynamically pooled during a pre-run phase in response to requests to participate in a single player computer game during a multi-player session. In that embodiment, a subsequent multi-user session may be opened by receiving an initial request to access the single player computer game subsequent to tolling of the previous pre-run phase. In that embodiment, one, or more than one pre-run phases may toll during the run phase of a previously opened multi-user session. Moreover, because no restriction is imposed on the runtime of a particular run phase, more than one multi-user session may overlap in time. Alternatively, where no additional requests to access the single player computer game are received in the interval between the tolling of the pre-run phase and closing of the first multi-player session, an idle phase may be entered until a first initial request to access the single player game is received anew.

Thus, the present application discloses a method and system for implementing a single user computer application in a multi-user session. By utilizing a multi-user shell application to provide an interface between a single user computer application and a multi-user control application, various embodiments of the present invention enable implementation of the single user computer application in a multi-user session. By further providing real-time data corresponding to the performance of members of a multi-user pool, one embodiment of the present invention provides real-time scoring in a multi-player game session and evokes a real-time presence of the members of the multi-player pool. Moreover, by dynamically adding users to a multi-user pool during a pre-run phase, one embodiment of the present invention provides a streamlined and user friendly opportunity for an unsophisticated or inexperienced user to enjoy a single user computer application in a multi-user session.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A method of implementing a single user computer application in a multi-user session, the method comprising:
receiving a first initial request to access the single user computer application from a first user;
opening a first multi-user session;
tolling a pre-run phase of the first multi-user session during which a multi-user pool is determined, the multi-user pool including the first user and one or more users joined during the pre-run phase; and
initiating a run phase of the first multi-user session during which concurrent running of the single user computer application by each user in the multi-user pool is monitored, and data corresponding to a performance of every user in the multi-user pool is provided to each user.

2. The method of claim 1, wherein the data corresponding to the performance of every user in the multi-user pool comprises a real-time score of every user in the multi-user pool.

3. The method of claim 1, further comprising terminating the run phase.

4. The method of claim 3, wherein the terminating the run phase occurs after a predetermined runtime.

5. The method of claim 1, further comprising closing the first multi-user session and providing each user with final data corresponding to a total first multi-user session performance of every user in the multi-user pool.

6. The method of claim 5, wherein the final data corresponding to the total first multi-user session performance of every user in the multi-user pool comprises a final score of every user in the multi-user pool.

7. The method of claim 1, further comprising opening a subsequent multi-user session when a subsequent initial request to access the single user computer application is received.

8. The method of claim 1, further comprising hosting an online chat for the users joined in the multi-user pool during the pre-run phase.

9. The method of claim 1, wherein the single user computer application comprises entertainment content.

10. The method of claim 1, wherein the single user computer application implemented in a multi-user session comprises a single player game implemented in multi-player game session.

11. A system for implementing a single user computer application in a multi-user session, the system comprising:
a multi-user implementation server;
a single user computer application database stored on the multi-user implementation server, the single user computer application database including the single user computer application;
a multi-user shell application configured to provide an interface between the single user computer application and a multi-user control application; and
the multi-user control application located on the multi-user implementation server, the multi-user control application capable of coordinating concurrently running the single user computer application by every user included in a multi-user pool, thereby implementing the single user computer application in the multi-user session.

12. The system of claim 11, wherein the single user computer application comprises entertainment content.

13. The system of claim 11, wherein the single user computer application implemented in a multi-user session comprises a single player game implemented in multi-player game session.

14. The system of claim 11, wherein the multi-user control application performs functions comprising:
receiving a first initial request to access the single user computer application from a first user;
opening a first multi-user session;
tolling a pre-run phase of the first multi-user session during which the multi-user pool is determined, the multi-user pool including the first user and one or more users joined during the pre-run phase; and
initiating a run phase of the first multi-user session during which concurrent running of the single user computer application by each user in the multi-user pool is monitored, and data corresponding to a performance of every user in the multi-user pool is provided to each user.

15. The system of claim 14, wherein the data corresponding to the performance of every user in the multi-user pool comprises a real-time score of every user in the multi-user pool.

16. The system of claim 14, wherein the functions performed by the multi-user control application further comprise terminating the run phase after a predetermined runtime.

17. The system of claim 14, wherein the functions performed by the multi-user control application further comprise closing the first multi-user session and providing each user with final data corresponding to a total first multi-user session performance of every user in the multi-user pool.

18. The system of claim 17, wherein the final data corresponding to the total first multi-user session performance of every user in the multi-user pool comprises a final score of every user in the multi-user pool.

19. The system of claim 14, wherein the functions performed by the multi-user control application further comprise opening a subsequent multi-user session when a subsequent initial request to access the single user computer application is received.

20. The system of claim 14, wherein the functions performed by the multi-user control application further comprise hosting an online chat for the users joined in the multi-user pool during the pre-run phase.
